(19) United States
(12) Patent Application Publication
(10) Pub. No.: US 2010/0106662 A1
(43) Pub. Date: Apr. 29, 2010

(54) Method and apparatus for in-store directions using visual or audio cues for current location determination

(76) Inventor: Satyanarayanan Ramaswamy, Cupertino, CA (US)

Correspondence Address: BRIGHTFON, INC., 7563 HOLLANDERRY PL., CUPERTINO, CA, 95014, US

(21) Appl. No.: 12/589,651

(22) Filed: Oct. 27, 2009

Related U.S. Application Data
(60) Provisional application No. 61/197,659, filed on Oct. 29, 2008.

(51) Int. Cl. G06Q 30/00; G06Q 10/00; G01C 21/00

(52) U.S. Cl. 705/323; 701/300

(57) ABSTRACT

The present invention relates in general to in-store direction systems, and more specifically to a method and apparatus that determine the current physical location of a given shopper in the store using only visual or audio cues in the store; and then provide a path from the shopper's current location to an item the shopper is looking for, while taking into account commercial objectives of the store in addition to the convenience of the shopper. The apparatus as in this invention comprises just the shopper's mobile terminal and a backend system. This invention avoids the use of radio-frequency based location detectors within the store and hence avoids capital costs associated with those. The interaction between the mobile terminal and the shopper is carried out using one of a plurality of methods including application packets, SMS/MMS, or voice. Once the current location of the shopper and the location of the item to which the shopper wants to go to is determined, the path between the two is selected to include locations where items are being promoted or items that are related to the item the shopper is seeking are located. The path displayed on the mobile terminal is annotated with the location of such promoted and related items.

### CROSS-REFERENCE TO RELATED APPLICATIONS

I hereby claim priority to my earlier filed Provisional patent application with Application No. 61/197,659 with filing-or-371(c) Date: Oct. 29, 2008

### BACKGROUND OF THE INVENTION

This invention relates in general to in-store direction systems, and more specifically to a method and apparatus that determine the current physical location of a given shopper in the store using only visual or audio cues in the store; and then provide a path from the shopper's current location to an item the shopper is looking for, while taking into account commercial objectives of the store in addition to the convenience of the shopper.

Retail stores around the world have been increasing in size. Average retail stores in the US are tens of thousands of square foot in floor area and can carry tens of thousands of items. This makes it very difficult and time consuming for shoppers to find the item they are looking for in such large stores. Even for regular shoppers, it is difficult to remember where certain items are located. As a result, shoppers typically move from aisle to aisle across the length and breadth of the store looking for certain items, thereby wasting time and energy. For retailers, this affects the throughput of the stores since shoppers take more time shopping for a given number of items. Retailers also miss the opportunity to gainfully make use of the time that shoppers spend in moving from one item to another since the retailers do not have a way of communicating to the shoppers when the shoppers are preoccupied with searching for their desired item. So, what is required is an efficient and cost-effective mechanism for aiding shoppers with finding the location of the item(s) they are looking for and providing them with an efficient path from their current location to the location in the store where the desired item is stocked. Such a path must also provide the retailer with an opportunity to promote certain items that may be related to the item(s) the shopper is looking for.

Most of the existing prior art solutions to the above problem depend on the use of radio-based triangulation techniques that use wireless sensors to detect the position of the shopper within the store. They also use a shopping list created by the shopper and conveyed to the in-store system to determine the next item to direct the shopper to. U.S. Pat. No. 6,912,507 teaches a system which uses short-range radio transmission such as Bluetooth to transmit location information or alternatively uses other radio techniques such as triangulation by multiple receivers or beacon transmitters to identify the aisle the shopper is in. The above patent also makes use of a shopping list to determine the next item to direct the shopper to. US Patent Application Pub. No. US 2008/0061973 A1 teaches a mobile platform such as a shopping cart where the location of the platform is determined using a plurality of radiation detectors which are screened from each other and limited in scope of view. U.S. Pat. No. 6,123,259 teaches a system in which a shopping list resident on a customer IC card is used in conjunction with a scanner in a mobile terminal to identify an item on the shopping list. The product UPC code scanned by the scanner in the mobile terminal is used to determine the current location of the shopper who is then directed by the shortest possible route to the next item on the shopper's shopping list. U.S. Pat. No. 7,308,356 teaches a system where radio pico-cells are positioned throughout the store to help in identifying the location information of the mobile terminal or shopping cart. This location information of the shopper is then used in conjunction with a shopping list provided by the shopper to direct the shopper to the next item on the shopping list. U.S. Pat. No. 6,563,423 teaches a location tracking system for tracking of individuals' location in physical spaces including in retail environments. An electronically readable tag comprised of a magnetic disposition is applied to an individual's footwear and then tracked using a plurality of proximity sensors. U.S. Pat. No. 6,986,463 B1 teaches a system and method for locating items in a retail store by broadcasting product information from a network of transmitters in the store and determining the distance to the product from a remote device from such broadcast information.

Use of radio based or magnetic tagging techniques as in the above prior art to determine the location of the shopper in a store is costly and complicated in terms of the infrastructure required to support such location determination. Radio transmitters and receivers need to be positioned throughout the store and support is also required from the mobile terminals carried by the shoppers. This will necessitate the use of specialized handheld terminals by the shoppers. These need to be provided to them on entry and collected back at exit. Use of scanners in the handheld terminals to scan the UPC code on the products also requires specialized mobile terminals, is also costly, and generally not available on the devices usually carried by the shoppers. The most common handheld devices used by shoppers are their own mobile phones. Even if their mobile phones support short-range wireless communication radio devices such as Bluetooth, enabling them upon entry to the store, pairing them with the store's transmitters and disabling them afterwards is cumbersome, aside from the infrastructure cost of positioning Bluetooth transmitters around the store. Use of long-range location technologies such as Global Positioning Satellite (GPS) or Cellular-based location determination is not possible within stores since the accuracy of such systems in enclosed areas is not sufficient to provide the precise location and direction determination needed within stores. Also, as distinct from most of the inventions in the prior art above that require a pre-constructed shopping list, in many instances a shopper may not be expected to have a shopping list entered into the system at all, but may have an impromptu question as to where a certain item is and how best to get to it from wherever he or she is currently. In the prior art discussed above the path from the shopper's current location to the next item is always determined to be the shortest path between the two. This may not be optimal from the perspective of commercial objectives of the store and even the convenience objectives of the shopper, especially when the shopper doesn't have a pre-configured shopping list. For example, the shortest path may take the shopper away from items that may be related to the item he is currently looking for and are also on promotion in the store.

In this invention, we present a method and apparatus for providing in-store directions to shoppers that do not depend on the deployment of location detecting radio technologies or other proximity-detecting infrastructure within the store. This invention also does not require optical scanners in mobile terminals to determine the shopper's current location within the store, nor does it require a pre-configured shopping list. Instead, this invention uses only the visual and audio cues within a store and a generic wide-area communication network (such as a cellular data network) that connects a backend system with a handheld device (such as a mobile phone typically carried by shoppers) to identify the shopper's location within a store and then direct the shopper to the item he is looking for. In addition, a priori setting up of a shopping list by the shopper is not required to guide the shopper from one item to the next. This invention also optimizes the path from the shopper's current location to the location of the item he is looking for by also considering the commercial objectives of the store.

### BRIEF SUMMARY OF THE INVENTION

This invention addresses the shortcomings associated with prior art as discussed above, by providing a method and apparatus to identify a shopper's current location in a retail store using only visual and audio cues in the store and then direct the shopper to the item he is looking for via a path in the store that balances the commercial objectives of the store with the convenience objectives of the shopper. The invention accomplishes this objective with the use of a mobile terminal that can communicate with a backend system via any commonly used wireless communication technology. The only requirement on the communication technology required for this invention is that it should be able to carry messages between the mobile terminal and the backend system or establish voice communication between the mobile terminal and the backend system. When a shopper requires a direction to a specific item in the store, the current location of the shopper is first determined by displaying or asking specific questions regarding visual or audio cues at the location where the shopper is currently located and obtaining his response via the mobile terminal. The shopper's response is compared with a pre-constructed database that associates possible shopper responses to specific locations in the store. Once the shopper's current location is determined, he is queried regarding the item he is looking for and the location of that item is determined from a pre-constructed database. Once the location of the shopper and the location of the item he is looking for are determined, a path between the two is determined taking into account the utility to the shopper as well as the retail store. This path may not be the shortest path between the two locations as taught in the referred prior art. As an example, in one preferred embodiment of this invention, that path could take the shopper via aisles or portions of aisles in the store that contain items that are related to the item the shopper is looking for or items the retail store is promoting. This is done with the objective of prompting the shopper to buy other items that are related to the item he is intending to buy.

Therefore, consistent with one aspect of the invention, the backend system displays a question to the shopper on the mobile terminal asking the shopper to enter portions of text from any of the labels of products, shelves, aisles, or displays nearest to him. When the shopper enters this information, it is compared with a preexisting database that maps such text to specific locations within the store in order to determine where the shopper must be for him to be seeing that text. If more than one location is possible for a given text entered by the shopper, then the shopper is asked to enter an additional text that is seen. This is repeated till the location of the shopper is determined.

Consistent with another aspect of the invention, the shopper is asked via voice communication to read out the text from the label of an item or shelf closest to him. A match of the text read out by the shopper is performed using voice recognition techniques with a preconstructed database to determine the current location of the shopper.

Consistent with still another aspect of the invention, the shopper is asked to take a picture of the shelf near him using the in-built camera in his mobile terminal. Such image is then transmitted to the backend system where a match is performed with a pre-existing database of pictures of shelves from all locations in the store. This is then used to determine the current location of the shopper.

Consistent with still another aspect of the invention, the shopper is asked to take an audio sample of the tunes or music being played at the specific location in the store where he is present. Such an audio sample is then transmitted to the backend system where a match is performed on a pre-existing database of audio from all locations in the store. This is then used to determine the current location of the shopper.

Consistent with another aspect of the invention, the path of the shopper to the location of the item he is looking for is determined so as to lead him through an area where items that are related to the item the shopper is looking for are located. For example, if the shopper is looking for cake mix, the path could take the shopper through the aisle that stocks sugar as long as such a path doesn't deviate too much from other shorter paths.

Consistent with still another aspect of the invention, the path of the shopper to the location of the item he is looking for is determined so as to lead the shopper through an area where items that are being currently promoted by the store are located.

Consistent with still another aspect of the invention, if multiple shortest paths from the shopper's current location to the location of the item he is looking for is available, then the path that results in the highest probability that the shopper will pick up an item that is related to the item he is looking for is selected.

### BRIEF DESCRIPTION OF THE SEVERAL VIEWS OF THE DRAWINGS

FIG. 1 is an exemplary simplified semi-schematic block diagram of a mobile terminal in accordance with this invention.

FIG. 2 is an exemplary simplified semi-schematic block diagram of the backend system in accordance with this invention.

FIG. 3 is an exemplary simplified block diagram illustrating the communication options that can be used to derive the benefits in accordance with this invention.

FIG. 4 is a sample layout of a store with traversal paths of an image recording system and a store layout with possible paths illustrated in accordance with this invention.

FIG. 5 is an exemplary product label from which keywords and keyphrases can be extracted and matched to identify a shopper's location in accordance with this invention.

FIG. 6 is an exemplary shelf in a retail store showing some shelf text markings.

FIG. 7 is a conceptual layout of the database tables in accordance with this invention.

FIG. 8 is a conceptual layout of the display of the mobile terminal while the shopper is responding to the system query about nearby items or while the shopper is responding to system query about what item he is looking for in accordance with this invention.

FIG. 9 is a conceptual layout of the display of the mobile terminal showing the path to be followed by the shopper.

### DETAILED DESCRIPTION OF THE INVENTION

A preferred embodiment of this invention will be described below. It is to be understood that persons of skill in the appropriate arts may modify this invention as described below and yet achieve the favorable results of this invention. In this sense, the following description is to be considered a broad, teaching disclosure and not as limiting upon this invention.

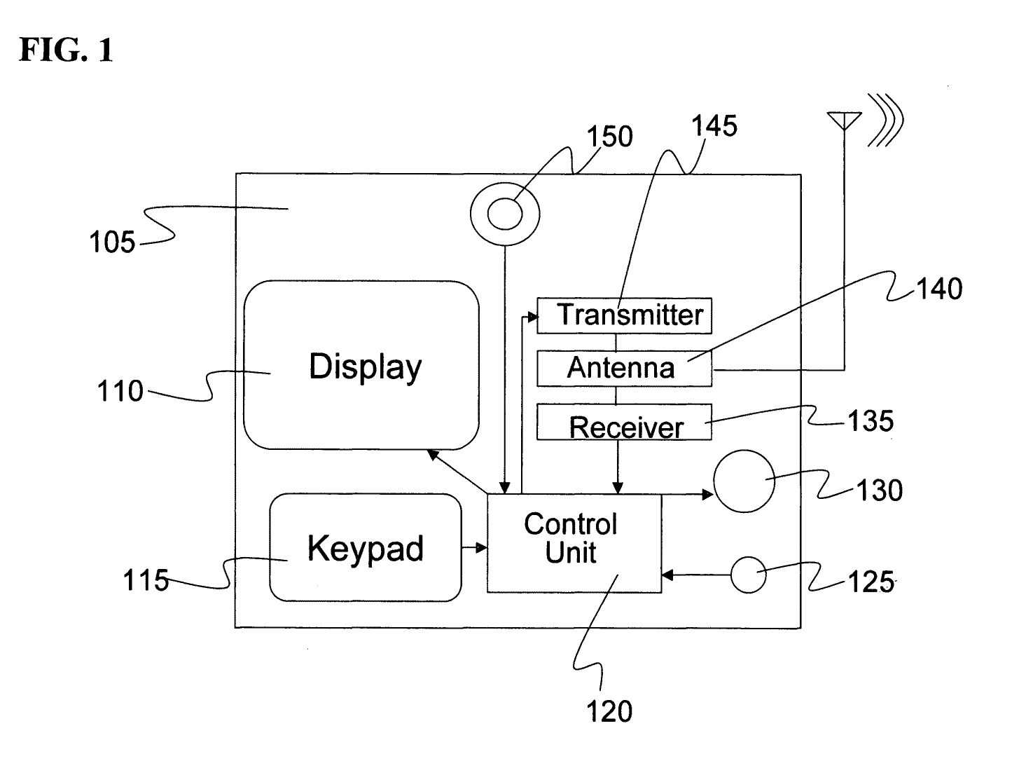

FIG. 1 presents a simplified semi-schematic block diagram of a mobile terminal operable in accordance with this invention. The mobile terminal 105 can be a handheld terminal such as a mobile phone belonging to the shopper or it could be a handheld device provided by the retail store to shoppers when they enter the store. The mobile terminal 105 may also be mounted on a shopping cart either on a permanent basis or in a temporarily detachable mode. As illustrated in FIG. 1, the mobile terminal consists of a display 110 that is used to display system responses and messages to the shopper. The mobile terminal also has a keypad 115 used to obtain shopper-typed inputs to the system. This keypad could be a physical keypad or it could be a soft keypad which is displayed on a touch sensitive display 110 and whose keys are activated by the shopper touching the appropriate displayed key that is desired to be activated. The mobile terminal has a control unit 120 that controls all other parts of the mobile terminal with either software or hardware commands. The mobile terminal may optionally have a microphone 125 that can be used to input verbal audio commands to the system and to listen to audio cues within the store. The speaker 130 in the mobile terminal is used to output audio results and commands from the system to the shopper. The control unit is also connected to a receiver 135, antenna 140 and a transmitter 145 that are used to communicate wirelessly with the backend system. Any one of a variety of technologies can be used to provide the communication link to/from the mobile terminal, the only key requirement being that the communication link used by the mobile terminal is wireless. The mobile terminal may also have a camera 150 using which a shopper can take images. It will be appreciated that the components of the mobile terminal 105 are typically available in mobile phones usually carried by shoppers. However, it will be evident to one having skill in the art that a mobile terminal with the above components can also be created specifically for providing the benefits and purposes of this invention and provided to shoppers by the retail stores.

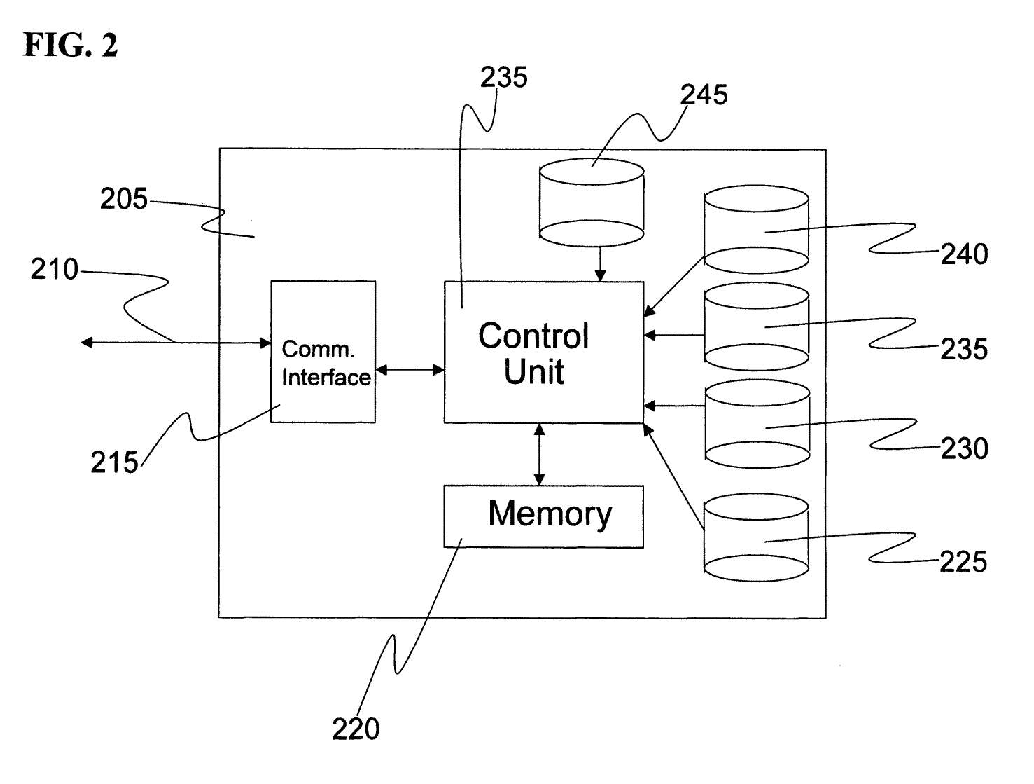

FIG. 2 presents a simplified semi-schematic block diagram of a backend system 205 operable in accordance with this invention. The backend system consists of a communication link 210 that is used to connect with a plurality of mobile terminals 105 via a wireless link. To that extent, the communication link may be comprised of different segments some of which are wired and others wireless, but with the only requirement being that the final link to the mobile terminal is wireless. The backend system is connected to the communication link via a communication interface 215 that interfaces the backend system with the communication link. The backend system is controlled by a control unit 235 that performs the logic of the backend as embodied in this invention and that controls the other components of the backend system. The control unit is connected to memory 220 to store and perform operations on the databases as presented in this invention. The backend system is connected to one or more of five databases 225, 230, 235, 240 and 245 depending on the specific embodiments of this invention that are supported, as will be apparent later in this description.

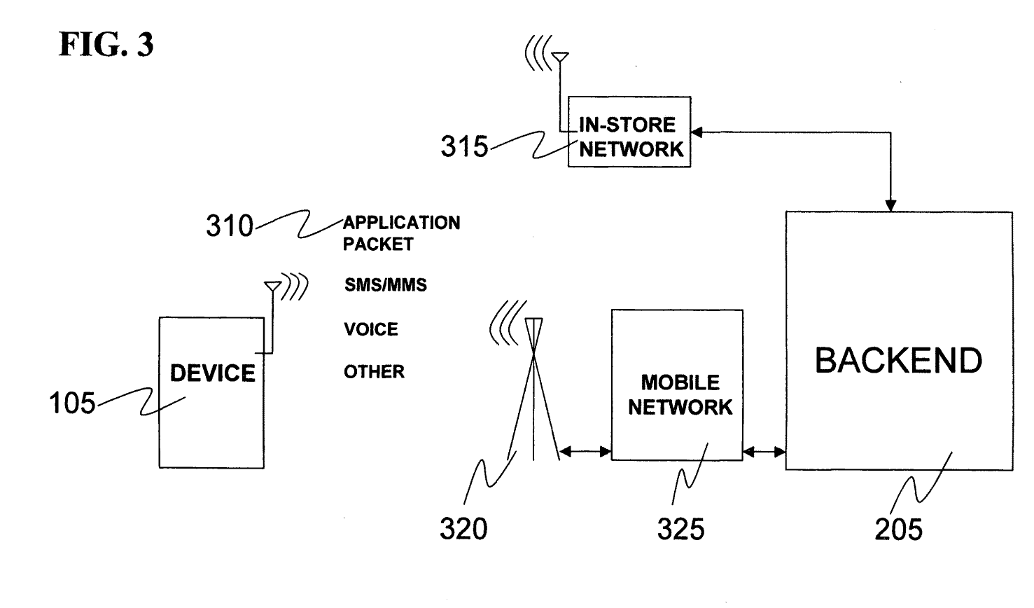

FIG. 3 illustrates two possible embodiments of the communication link that connects the mobile terminal 105 with the backend system 205. In one preferred embodiment of this invention, the mobile terminal is connected to the backend system via a normal cellular communication system 320 such as CDMA, GSM, UMTS, Wi-Max, etc. In another preferred embodiment of the system, the mobile terminal is connected to the backend system via an in-store communication network 315 using technologies such as Wi-Fi. These wireless networks are used for communication purposes only and do not perform any proximity detection function as in prior art. The mobile terminal and the backend system can communicate commands and responses with each other using one of many possible mechanisms 310. This could include application data packets such as those on networks based on the Internet Protocol standards, Short Message Service (SMS) or Multimedia Messaging Service (MMS), Voice, or any other suitable communication technique that is understood by the mobile terminal and the backend system.

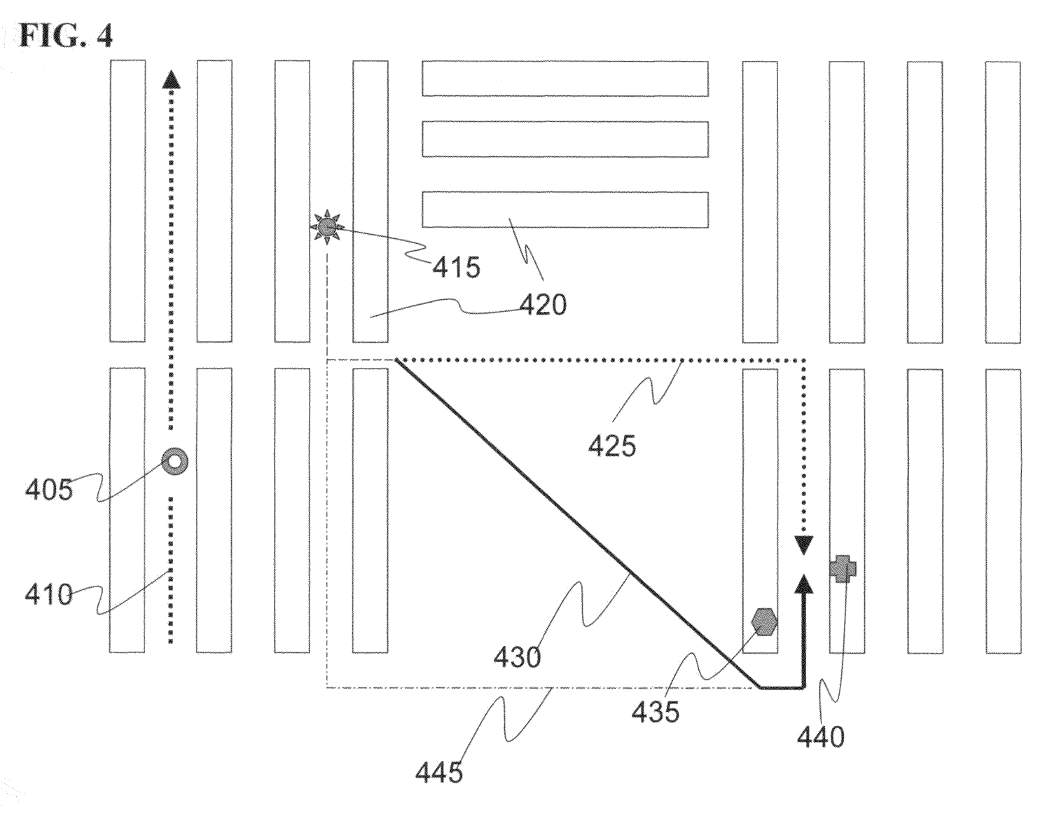

Operation of a particular embodiment of a mobile terminal and backend system in accordance with the practice of principles of this invention will be described below. For purposes of illustration, without loss of generality, consider that the layout of an exemplary retail store is as in FIG. 4. It will evident to one having skill in the art that the layout could be quite different without affecting the application of the principles of this invention. For example, the shelves in the store could be arranged in a circle. The shelves 420 in the store are divided into sections for location identification, with each section having a unique identity, such as for example 45, 4A, RG, etc.

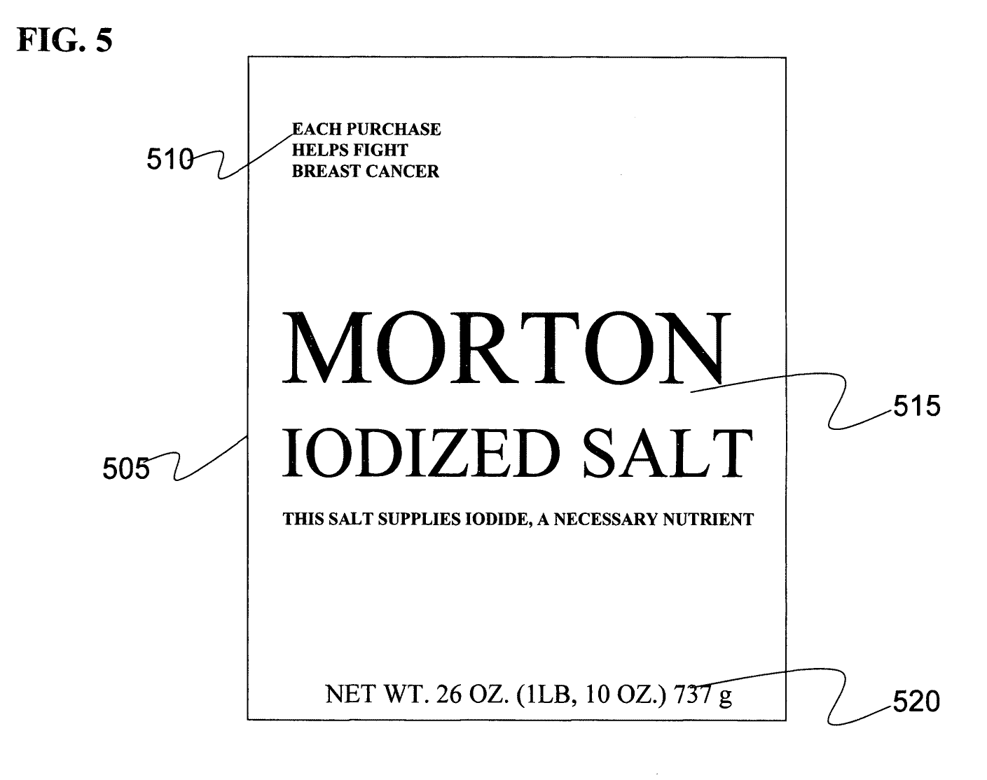

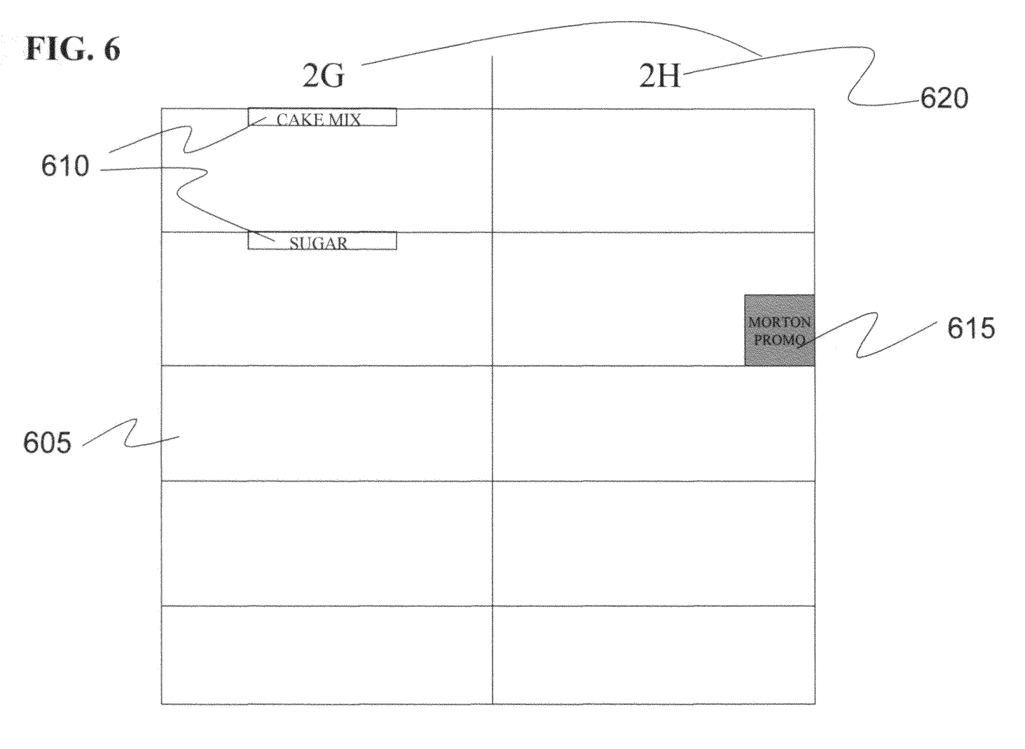

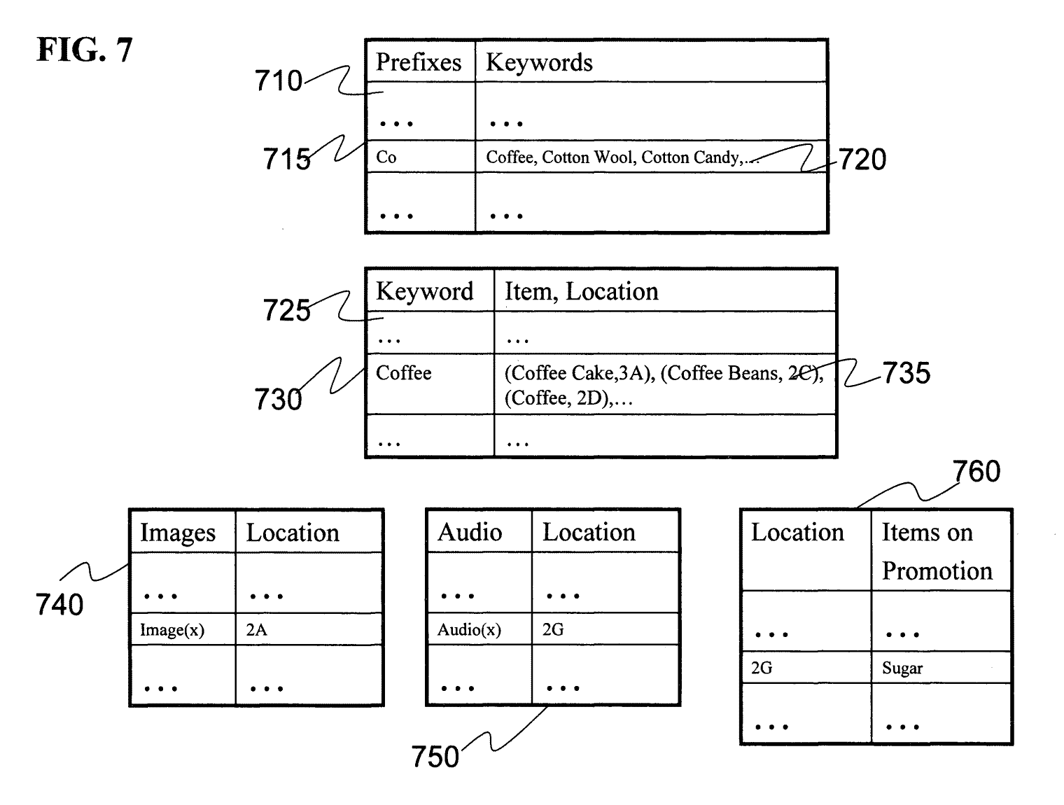

As a first step in an embodiment of this invention, a database 225 is created which associates every item in the store with every unique keyword of text and/or keyphrase of text on the label of the item (as in table 725 in FIG. 7) and every prefix of every such keyword or keyphrase (as in table 710 in FIG. 7). As an example, consider an exemplary product label in FIG. 5. From this particular product label 505, a number of keywords and keyphrases can be extracted. For example, ‘each purchase’, ‘helps fight’, ‘breast cancer’, ‘cancer’, ‘morton’, ‘iodized salt’, ‘salt’, ‘iodide’, ‘nutrient’, ‘26 oz’, ‘737 g’ are all valid keywords and keyphrases that can be extracted from the exemplary label 505. It would be appreciated that the same keyword could be associated with more than one item as can be seen in the example in table 725 in FIG. 7 where the keyword ‘coffee’ is associated with more than one item. For each keyword or keyphrase so extracted, all prefixes are also generated. For example, for the keyword ‘morton’, the prefixes would be ‘m’, ‘mo’, ‘mor’, ‘morto’, ‘morton’. Each item in table 725 in the database is then also linked to a specific location in the store where it is located. For example, the above product illustrated in FIG. 5. could be linked to location 2G. Secondly, all textual information on shelves and displays around the store, their prefixes, along with the specific location in the store where such text appears is also added to the database 225 as discussed above. Consider an exemplary shelf in the store 605 as in FIG. 6. The keywords from text markings 610, 615, and 620 and all their prefixes are associated with the specific location of this shelf in the database 225.

The first step in aiding the shopper with directions to the item he is looking for is to uniquely identify the location where the shopper is currently located within the store.

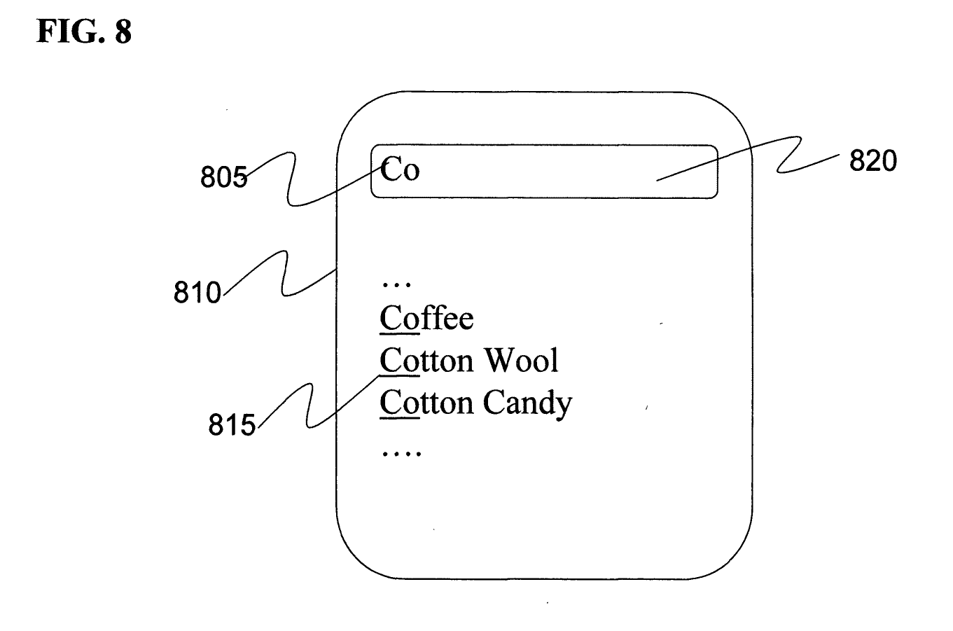

In one preferred embodiment of this invention, the communication between the mobile terminal and the backend is via application messages. Upon receiving a request from the mobile terminal for help, the backend system sends back a message to the mobile terminal asking the shopper to enter a word or phrase on a product label, shelf, or display near where the shopper is currently located. FIG. 8 shows an exemplary layout of the display for entering this text. With every character the shopper enters using the keypad 115, the set of characters the shopper has entered so far is sent to the backend system and a set of keyword/keyphrase suggestions are sent back to the mobile terminal for display from the backend system by matching the shopper entered text with elements of the databases 225 described earlier. Once the shopper finds on the display, a keyword or keyphrase 815 that he sees from his current location, he selects that from the list by using the keypad and display. The backend system then matches this keyword or keyphrase with those in the database 225. If more than one match is found for the text entered by the shopper, the backend system sends a message back to the mobile terminal for display, asking the shopper to enter one more keyword or keyphrase. The above process is repeated until the location of the shopper in the store is uniquely determined by matching the keyword(s)/keyphrase(s) or a combination of keyword(s)/keyphrase(s) selected by the shopper with a specific location in the store using the database 225. Alternatively the shopper can enter complete keyword(s) or keyphrase(s) without any suggestion from the backend system as described above and then the location of the shopper is determined by simply matching the user-entered keyword(s) or keyphrase(s) with entries in database 225. Optionally, a further confirmation step can be added wherein the backend system can send an image of the product, shelf, or display containing the matched text, requesting the user to confirm if that is what he is seeing at the store location where he is.

If the communication between the mobile terminal and the backend system is via SMS or MMS, then the operation of the system is similar to the embodiment above except that it would be cumbersome for the shopper to send an SMS/MMS with prefixes of keywords/keyphrases. In such an embodiment, full keywords or keyphrases are sent to the backend system from the mobile terminal using SMS or MMS and the current location of the shopper is determined by matching these with database 225.

In another embodiment of this invention, the interaction between the shopper and the backend system is via the voice channel. The backend system sends its messages to the shopper as voice commands and the user responds back into the mobile terminal using voice. The backend system converts the shopper's voice responses into text and the subsequent operations is exactly as it is when the shopper responses are obtained in text form.

In another particular embodiment of this invention, instead of requiring the shopper to enter keywords/keyphrases from his current location, an image from the place where the shopper is located is requested by the backend to determine the current location of the shopper within the store. Once again, consider the layout of a store as in FIG. 4. As a first step, a database is created containing a catalog of images of shelves and surrounding spaces as seen from different identified sections of the store. This database could be created in multiple ways. One method is to use a mobile camera 405 that is capable of 360° image capture. This mobile camera is carried along the aisles of the store and a sequence of images are captured from each individual section of the aisles on all directions while recording the identity of the section the camera is currently in. Alternatively, the front image of individual products that are in a given section are combined off-line to create such an image. The above information is captured in the database 230 in the backend system. Table 740 in FIG. 7 presents an example of format of this database. When a request for directions is received from a shopper at a mobile terminal, the backend system sends a request to the shopper to capture an image of the adjacent shelf and send it back to the system. The shopper then uses the camera 150 on his mobile terminal to capture an image of one of the surrounding shelves. That image is then sent back to the backend system. The backend system then uses the database of shelf images 230 to compare the image sent by the mobile terminal with the precaptured images and thereby identifies the current location of the shopper.

In yet another embodiment of this invention, directional speakers are placed along the shelves of the store such that the output of a given speaker can be heard only within a small distance from the speaker. Each speaker outputs a uniquely defined tune or strain of music that can be uniquely identified and associated with a particular location in the store as in table 750 in FIG. 7. This table is stored in database 235. When a request for directions is received from a shopper at a mobile terminal, the backend system sends a request to the shopper to position the microphone 125 in the mobile terminal so as to enable the capture of the audio tune or music being played in that area. This audio sample is then sent back to the backend system from the mobile. The backend system then uses a database of audio tunes and store locations 235 to compare the audio sample sent by the mobile terminal to uniquely identify the current location of the shopper.

Once the current location of the shopper in the store is uniquely determined by one of the embodiments above, then the location of the item the shopper is looking for is determined by the following set of message exchanges between the mobile terminal and the backend system. In one embodiment of this invention, the backend system sends a message to the mobile terminal asking the shopper to enter a keyword corresponding to the item that the shopper is looking for. Except when using SMS/MMS for communication, when the shopper enters every character using the keypad 115, the set of characters so far entered by the shopper is sent by the mobile terminal to the backend system. A set of possible keyword/keyphrase suggestions are sent back for display to the mobile terminal by the backend system as exemplified in FIG. 8. When the shopper sees the keyword/keyphrase he had in mind on the display 110, he selects that keyword. This keyword/keyphrase selection is conveyed to the backend system by the mobile terminal. When using SMS/MMS for communication, the full keyword is sent in one message. When the backend system receives this keyword, it matches this keyword in the database 225 and sends the items with matching keywords to the mobile terminal for display. The shopper selects the item he is looking for. This selection is conveyed to the backend system from the mobile terminal. Upon receiving this, the backend system matches the item with its location. The backend system then computes possible paths between the shopper's current location and the location of the item he is looking for as described below.

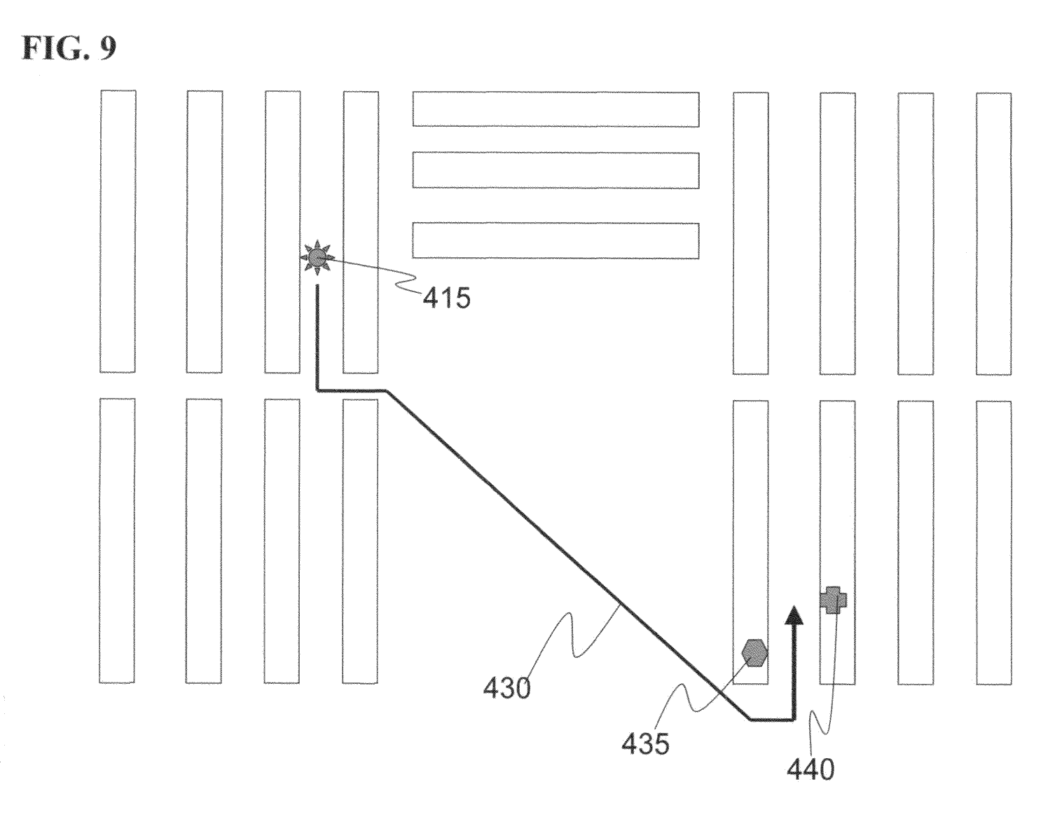

For an illustration of an embodiment of the path determination, consider the scenario in FIG. 4. Consider that the shopper is currently located in the position denoted by 415 and that the item he is looking for is at location 440. Having determined the shopper's current location 415 and the location of the item he is looking for 440 as in the preceding embodiments, the backend system then would identify three paths from 415 to 440 as possible options. These are the paths denoted by 425, 430 and 445. The backend system has to determine which of the three paths to suggest to the shopper in order for him to reach 440. The backend system searches its database of related and promotional items 240 to determine if any item related to the item 440 is on any of these three paths. The backend system determines that it has one such item 435 that is on two of the paths. The backend system determines that path 425 has no promotional or related items on it. Though this is the shortest path to the item the shopper is looking for, it is discarded from consideration. The two remaining paths 430 and 445 take the shopper via the item 435 that is related to the item the shopper is looking for. Among these two paths, path 430 is chosen since it is the shortest of the two paths 430 and 445 that also has a potential to provide an incremental sale to the store from this shopper. Once the path determination is completed, the path from the shopper's current location 415 to the location of the item he is looking for 440 is sent from the backend system to the mobile terminal for display including a map as in FIG. 9. In such a map, the current location of the shopper 415, location of the item he is looking for 440, and the path 430 are marked. In addition, the location of the related item 435 is also annotated in the map with an indication as to why it is being highlighted—for example, that it is a related item or it is being promoted etc.

In yet another embodiment of this system, the interaction between the mobile terminal and backend system is performed on voice channels as described below. When a shopper wants in-store directions, he dials a particular phone number. This phone number is connected to the backend system 205 via a communication interface 210. The backend system requests the shopper via the speaker 130 in the mobile terminal to read any text seen in nearby products, shelves, or displays. The shopper then reads any word or phrase seen on those into the microphone 125. The backend system recognizes this speech sample, converts it into text and compares the resulting text description with items in its database 225. If a unique match is found, then the corresponding location in the database is identified as the current location of the shopper. If multiple matches are found, the backend system instructs the shopper via the speaker 130 to read additional keywords or phrases of text found nearby. This is repeated till a unique match is found. Once the shopper's current location is found, the backend system requests via the speaker 130 for the shopper to speak out the item he is looking for. The shopper's speech is captured via the microphone 125 by the backend system that then converts it to text and uses its item database 225 to match the shopper's request. Once a match is found, the location of the matched item is identified. The path from the shopper's current location to the item he is looking for is determined as in the earlier embodiments. Then the shopper is guided to the destination location 440 using voice prompts provided by the backend system to the shopper via the speaker 130. The shopper is also alerted to the presence of related or promotional items 435 on the path selected by using voice announcements.

What is claimed is:

1. A method and apparatus for providing in-store directions to shoppers wherein the shopper's current location within the store is determined using just visual or audio cues available near the shopper's location within the store, the apparatus comprising a handheld mobile terminal used by the shopper and a backend system with a pre-compiled database of such cues and their corresponding locations within the store, the method comprising of first detecting the shopper's current location by requesting the user to provide one or more visual or audio cue(s) near his current location, matching the cue(s) with the pre-complied database of cues to determine the current location of the shopper, then asking the shopper for the item he wants to go to, computing the path(s) from the shopper's current location to the location he wants to go to and selecting one of the paths and providing it to the shopper via the mobile terminal.

2. The method of claim 1, wherein the visual cue used to determine the shopper's location is the text on the label(s) of one or more products near where the shopper is located.

3. The method of claim 1, wherein the visual cue used to determine the shopper's location is the text on the labeling of a product shelf near where the shopper is located.

4. The method of claim 1, wherein the visual cue used to determine the shopper's location is the text on the labeling of an aisle near where the shopper is located.

5. The method of claim 1, wherein the visual cue used to determine the shopper's location is a photograph taken by the user at the location where he is located.

6. The method of claim 1, wherein the audio cue used to determine the shopper's location is a localized tune or music played at the location where the shopper is located.

7. The method of claim 1, wherein the communication between the mobile terminal and the backend is via an application packet.

8. The method of claim 1, wherein the communication between the mobile terminal and the backend is via Short Message Service (SMS) or Multimedia Messaging Service (MMS).

9. The method of claim 1, wherein the communication between the mobile terminal and the backend is via voice commands.

10. The method of claim 1, wherein the visual cue text or phrase is suggested by the backend with every character entered by the user on the mobile terminal.

11. The method of claim 1, wherein the product to which the shopper wants to go to is suggested by the backend with every character entered by the user on the mobile terminal.

12. A method and apparatus for providing in-store directions to shoppers wherein the path provided from the shopper's current location to the location of the item he wants to go to is determined by taking into account the commercial interests of the retailer in addition to the convenience of the shopper, the apparatus comprising a handheld mobile terminal used by the shopper and a backend system that can incorporate the retailer's commercial interests in determining the path.

13. The method of claim 12, wherein the path from the shopper's current location to the location of the item he wants to go to includes locations where items are being promoted.

14. The method of claim 12, wherein the path from the shopper's current location to the location of the item he wants to go to includes items that are related to the item to which the shopper wants to go to.

15. The method of claim 12, wherein the segments of the path displayed to the user is annotated with the reason why that segment is included in the path.

16. The method of claim 12, wherein the segments of the path displayed to the user is annotated with the items that are being promoted.

17. The method of claim 12, wherein the segments of the path displayed to the user is annotated with items that are related to the item to which the shopper wants to go to.
